(19) United States
(12) Patent Application Publication
(10) Pub. No.: US 2024/0407349 A1
(43) Pub. Date: Dec. 12, 2024

(54) LINE GUIDE MECHANISM FOR SPINNING REEL

(71) Applicant: Shimano Inc., Osaka (JP)

(72) Inventors: Koji OCHIAI, Osaka (JP); Takafumi TSUJI, Osaka (JP); Kenji YOSHIDA, Osaka (JP)

(21) Appl. No.: 18/628,514

(22) Filed: Apr. 5, 2024

(30) Foreign Application Priority Data
Jun. 8, 2023 (JP) 2023-095005

(51) Int. Cl. A01K 89/01

(52) U.S. Cl. CPC A01K 89/01081

(57) ABSTRACT

A line guiding mechanism for a spinning reel includes a spool, rotor arms for winding a fishing line around the spool, a first support part supported by a rotor arm, a line roller disposed on the first support part and that guides fishing line onto the spool, and a fin. A proximal end part of the fin is disposed on a first support part and a distal end part of the fin has a line guide part facing the line roller and configured to pivotably move.

### CROSS-REFERENCE TO RELATED APPLICATIONS

This application claims priority to Japanese Patent Application No. 2023-095005, filed on Jun. 8, 2023. The entire disclosure of Japanese Patent Application No. 2023-095005 is hereby incorporated by reference.

### BACKGROUND

### Technical Field

The present disclosure relates to a line guide mechanism for a spinning reel.

### Background Information

Conventional spinning reels for fishing of the prior art generally include a spool and a rotor for winding fishing line around the spool. The rotor includes a rotor arm and a support part supported by the rotor arm, and the support part includes a line guide mechanism with a line roller that guides the fishing line to the spool. Such a line guide mechanism that is provided with a line slack prevention fin to prevent slackening of the fishing line is known, for example, as shown in Japanese Patent Publication No. 2021-087419.

### SUMMARY

Knots can be provided in fishing lines to mark the fishing line or to stop the fishing line from floating, and with the type of line slack prevention fin shown in Japanese Patent Publication No. 2021-087419, it has been determined that such knots can cause considerable damage to the fin as the knots pass through the fin.

Further, the sensation felt in the hand as the knots pass through the fin cause discomfort, so that there is also room for improvement in this regard.

The present disclosure was conceived in consideration of these circumstances, and the purpose thereof is to provide a line guide mechanism for a spinning reel that can prevent damage to the fin and minimize the discomfort felt in the hand when knots in the fishing line knot pass through the fin.

A first aspect of the present disclosure concerns a spinning reel that includes a spool, rotor arms for winding fishing line around the spool, and a support part supported by the rotor arm, wherein the spinning reel also includes a line guide mechanism with a line roller that is disposed on the support part and that guides the fishing line onto the spool, and a fin, the proximal end part of which is disposed on the support part and the distal end part of which is pivotable and faces the line roller.

According to the first aspect of the line guide mechanism for a spinning reel of the present disclosure, since the distal end part of the fin facing the line roller is capable of pivoting, knots, etc., in the fishing line can pass through the distal end part of the fin, pushing and pivoting the fin in the direction in which the fishing line is guided. Therefore, damage to the fin due to intense contact of a knot with the distal end part of the fin can be prevented.

Further, in the present disclosure, the pivoting of the fin makes it difficult to generate sufficient impact that would cause a knot in the fishing line to go over the fin as the knot passes through the distal end part of the fin. Therefore, the discomfort felt in the hand of the user can be minimized by the rotor arm that includes the fin.

According to a second aspect of the present disclosure, in the line guide mechanism for a spinning reel according to the first aspect, the proximal end part of the fin preferably has a pivot shaft that pivotably supports the fin with respect to the support part.

In the second aspect of the present disclosure, when a knot passes through the distal end part of the fin, the fin pivots about the pivot shaft disposed at the proximal end part. In this embodiment, since the pivot shaft is provided at the proximal end part of the fin, which is farthest from the distal end part in the fin, the pivot radius can be large, and the fin itself can easily pivot, even when met with by a small contact force from a knot passing through the distal end part of the fin, thereby minimizing the discomfort felt by the hand during contact.

According to a third aspect of the present disclosure, in the line guide mechanism for a spinning reel according to the second aspect, the pivot shaft is preferably a detachable pin element that supports the fin.

In this embodiment, the pin element, such as a fixing bolt, is the pivot shaft, and the fin can be smoothly rotated and pivoted about the pin element, so that the impact during passage of a knot can be reduced.

According to a fourth aspect of the present disclosure, in the line guide mechanism for a spinning reel according to the second or third aspect, the support part has a holding part that holds the distal end part in a holding position facing the line roller, and the holding part includes a biasing element that biases the fin to pivotably move about the pivot shaft in a second direction opposite to a first direction, i.e., the direction in which the fishing line is guided onto the spool.

In this embodiment, when a knot passes through the distal end part of the fin, the fin, the distal end part of which pivots about the pivot shaft in the first direction from the holding position, can move in the second direction and return to original holding position by the biasing force of the biasing element that forms part of the holding part. That is, according to the fourth aspect of the present disclosure, when a knot does not pass through the distal end part of the fin, the distal end part of the fin can always be positioned in a position facing the line roller by the biasing force of the biasing element, and the fishing line can be held between the line roller and the distal end part.

According to a fifth aspect of the present disclosure, in the line guide mechanism for a spinning reel according to the first aspect, the fin has a connecting portion between the proximal end part and the distal end part, which connects the distal end part so as to pivotably move with respect to the proximal end part.

In the fifth aspect of the present disclosure, when a knot passes through the distal end part of the fin, the fin pivots about the connecting portion between the proximal end part and the distal end part, which acts as a pivot axis. In this embodiment, since the connecting portion is disposed on the fin itself, there is no need to provide a pivot shaft separately from the fin, and a pivotable fin with a simple structure can be provided.

According to a sixth aspect of the present disclosure, in the line guide mechanism for a spinning reel of the fifth aspect, the connecting portion has an elastically deformable portion.

In the fifth aspect of the present disclosure, when a knot passes through the distal end part of the fin, the fin pivots about the elastically deformable portion between the proximal end part and the distal end part, which acts as a pivot axis. In this embodiment, for example, an attenuated or accordion-like section can be made into the elastically deformable portion, and the distal end part can be easily pivoted by the small contact force of a knot passing through the distal end part, thereby minimizing the discomfort felt in the hand of the user during contact.

By the line guide mechanism for a spinning reel of the present disclosure, it is possible to prevent damage to the fin and to minimize the discomfort felt in the hand of the user as a knot passes through the fin.

### BRIEF DESCRIPTION OF THE DRAWINGS

FIG. 1 is a perspective view showing the overall structure of a spinning reel for fishing according to a first embodiment of the present disclosure.

FIG. 2 is a perspective view of the line guide mechanism shown in FIG. 1.

FIG. 3 is a partial cutaway perspective view of the line guide mechanism shown in FIG. 2.

FIG. 4 is a perspective view showing the configuration of the spring element in the line guide mechanism shown in FIG. 2.

FIG. 5 is a perspective view of the line guide mechanism according to a second embodiment.

FIG. 6 is a vertical longitudinal sectional view of the line guide mechanism according to a third embodiment.

FIG. 7 is a vertical longitudinal sectional view showing the state in which the fin pivots in the line guide mechanism shown in FIG. 6.

FIG. 8 is a perspective view of the line guide mechanism according to a fourth embodiment.

FIG. 9 is a perspective view of the line guide mechanism according to a fifth embodiment.

FIG. 10 is a perspective view of the line guide mechanism according to a sixth embodiment.

FIG. 11 is perspective view of the line guide mechanism according to a seventh embodiment.

### DETAILED DESCRIPTION OF EMBODIMENTS

Embodiments of the line guide mechanism for a spinning reel according to the present disclosure will be described below with reference to the drawings. It should be noted that in each drawing the scale of each component can be changed as necessary in order to bring each component to a discernible size.

### First Embodiment

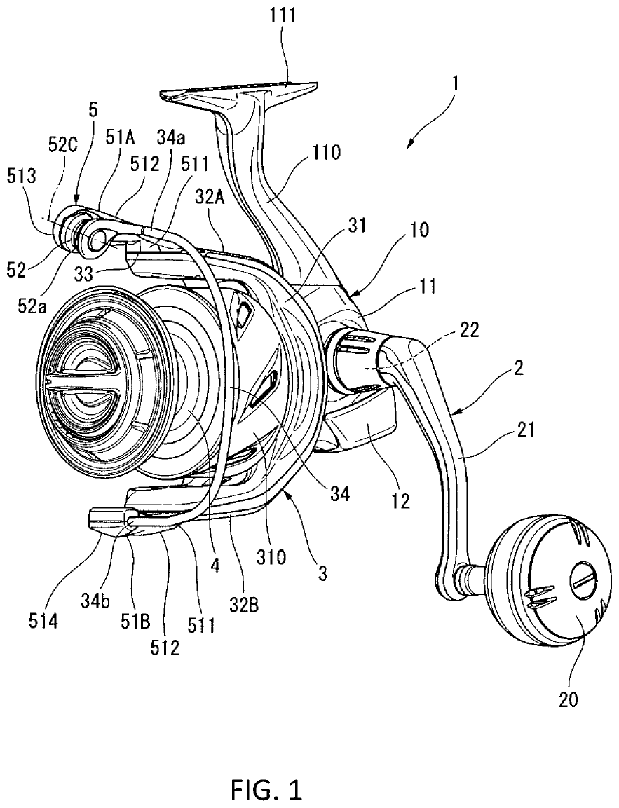

As shown in FIG. 1, the line guide mechanism for a spinning reel of the present embodiment is applied to a spinning reel for fishing 1 (i.e., a fishing reel).

The spinning reel for fishing 1 has a reel body 10, a handle 2 rotatably supported by the reel body 10, a spool 4, a rotor 3 that winds a fishing line L around the spool 4 in response to the rotation of the handle 2, and a line guide mechanism 5 which is disposed on the rotor 3 and which guide fishing line L onto the spool 4.

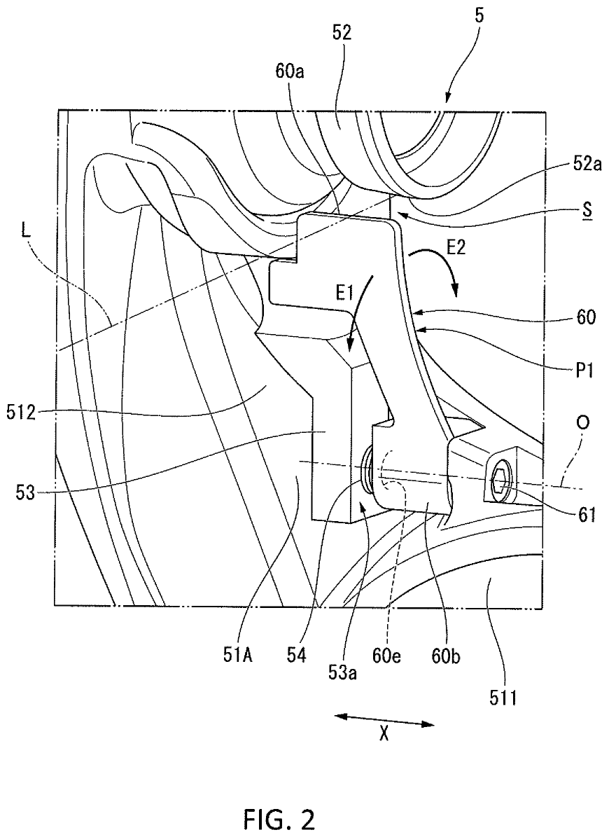

The rotor 3 is rotatably supported at the front of the reel body 10. The spool 4 winds fishing line L (see FIG. 2) around its outer circumferential surface and is arranged at the front of the rotor 3 so as to be movable back and forth. In FIG. 1, the handle 2 is attached for use to the left side of the reel body 10. The handle 2 can be attached to either the left or right side of the reel body 10.

The handle 2 has a handle knob 20 and a handle arm 21 to the end of which the handle knob 20 is rotatably attached. The proximal end part of the handle arm 21 is non-rotatably attached to a handle shaft 22 that extends in a direction intersect the handle arm 21. The handle shaft 22 is integrally rotatably and detachably connected to a gear shaft, not shown.

The reel body 10 has a reel body portion 11 with an interior space, and a cover 12 that is detachably attached to the reel body portion 11 to close the space of the reel body portion 11.

The reel body portion 11 is integrally molded with a leg portion 110 extending upward and a T-shaped rod attachment portion 111 extending in the front and rear directions from the upper end of the leg 110. The reel body portion 11 has an internal mounting space for mounting each mechanical part. The cover 12 is made of an aluminum alloy, for example, covers the rear part of the reel body portion 11, and is attached to the reel body portion 11 at a plurality of locations.

A spool shaft of the spool 4 is passed through and is rotatably supported by the reel body portion 11. The reel body portion 11 and the cover 12 each have circular through-holes, not shown, through which the handle shaft 22 can be inserted. A roller bearing (not shown) that rotatably supports the handle shaft 22 is housed around the through-holes on the inner surface of the reel body portion 11 and cover 12.

The spool 4 is disposed between the pair of opposing rotor arms 32A, 32B of the rotor 3. The spool 4 is attached to the end of the spool shaft via a drag mechanism (not shown). The spool 4 has a spool bobbin around the circumference of which fishing line L is wound. The spool 4 moves in reciprocating fashion with respect to the reel body 10 as the handle 2 is turned.

The rotor 3 is rotatably supported by the reel body 10 and rotates about the central axis of the spool 4 as the handle 2 is turned. The rotor 3 comprises a rotor main body 31, a pair of rotor arms 32A, 32B that are attached to the end of the rotor main body 31 so as to pivotably move between a fishing line open position and a fishing line winding position, and a bail reversing mechanism 33 mounted on the rotor main body 31 to return the rotor arms 32A, 32B from the fishing line open position to the fishing line winding position.

The rotor main body 31 has a cylindrical portion 310 that is mounted in the reel body portion 11 so as to rotate about the spool axis.

The rotor arms 32A, 32B are disposed on the sides of the cylindrical portion 310 so as to oppose each other. The cylindrical portion 310 and rotor arms 32A, 32B are made of an aluminum alloy, for example, and are integrally molded. A bail 34 in the form of a wire rod bent into a U-like shape for guiding fishing line L onto the spool 4, is fixed between the ends of the opposing rotor arms 32A, 32B opposed.

The line guide mechanism 5 rotates together with the rotor 3 about the central axis of the spool 4, guiding fishing line L onto the spool 4. The line guide mechanism 5 comprises the above-described spool 4, rotor arms 32A, 32B that wind fishing line L about the spool 4, support parts 51A, 51B supported by the rotor arms 32A, 32B, respectively, a line roller 52 disposed on one first support part 51A for guiding fishing line L onto the spool 4, and, as shown in FIG. 2, a pivot shaft 61 disposed on the first support part 51A, and a fin 60 with a line guide part 60a (distal end part) that can be pivoted and that faces the line roller 52.

Here, as shown in FIG. 2, in the following description, in the fin 60, the pivot shaft 61 is disposed in the same direction as a rotary shaft 52C of the line roller 52 (see FIG. 1), the center of the pivot shaft 61 is defined as the pivot center axis O, and the direction along the pivot center axis O is defined as the axial direction X. Further, in a plan view seen from axial direction X, a direction orthogonal to the pivot center axis O is defined as the radial direction, and a direction encircling the pivot center axis O is defined as the circumferential direction.

Further, in the first support part 51A, the side on which the bail 34 is fixed in the axial direction X is defined as the interior, and the side opposite the interior is defined as the exterior.

As shown in FIGS. 1 and 2, the support parts 51A, 51B are disposed at the ends of the rotor arms 32A, 32B, respectively. The first support part 51A includes an attachment part 511 that is pivotably attached to the end of the first rotor arm 32A, an extended part 512 that extends from the attachment part 511, a first support part 513 that is disposed at the end of the extended part 512, rotatably supports the line roller 52, and fixes one end 34a of the bail 34. The second support part 51B includes an attachment part 511 pivotably attached to the end of the second rotor arm 32B, an extended part 512 that extends from the attachment part 511, and a second support part 514 that is disposed at the end of the extended part 512 and fixes the other end 34b of the bail 34.

As shown in FIG. 1, the line roller 52 has a line guide groove 52a in the axial center and is rotatably supported by the first support portion 513 of the first support part 51A to guide fishing line L onto the spool 4. The line roller 52 is supported via a bearing (not shown) mounted on the first support portion 513 and rotates around the rotation shaft 52C.

One end 34a of the bail 34 is supported by the first support part 51A and the other end 34b is supported by the second support part 51B. The bail 34 is pivotably supported by the pair of rotor arms 32A, 32B and guides fishing line L to the line roller 52.

As shown in FIG. 2, the extended part 512 extends in the front-rear direction of the reel. The inner surface 512a of the extended part 512 of the first support part 51A includes a flat fixing plate 53 having an inner fixing surface 53a facing inwards and orthogonal to axial direction X. The inner fixing surface 53a of the fixing plate 53 is formed with a female-threaded portion 53b into which the pivot shaft 61 is screwed.

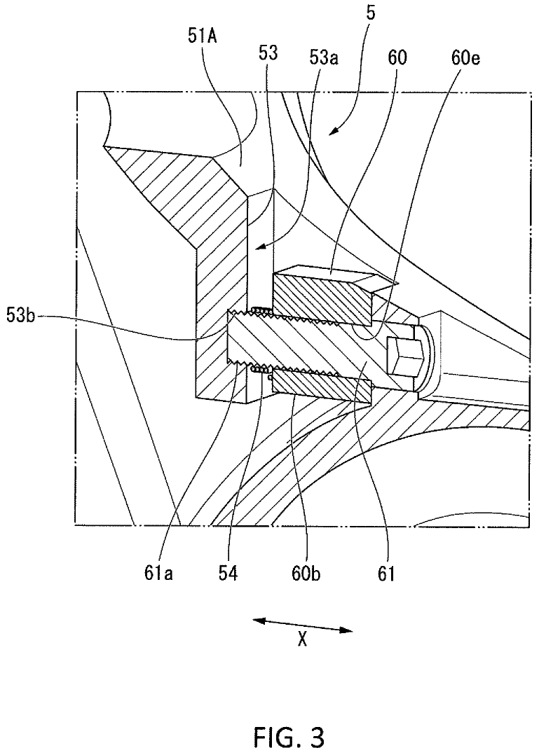

The fin 60 is pivotably connected to the first support part 51A of the first rotor arm 32A, thereby being able to assume a holding position P1 opposite the line roller 52 and to be pivoted into a pivot position P2 (see FIG. 3) in the line-winding direction (guide direction E1) in which the fin is not opposite the line roller 52.

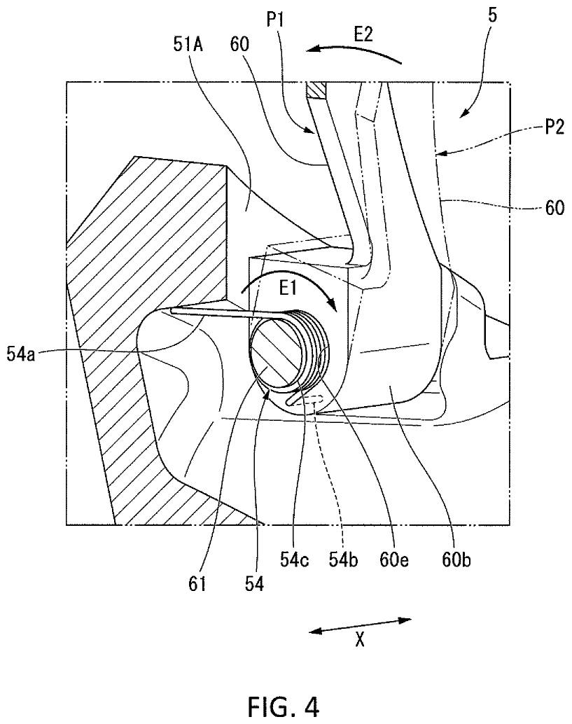

The fin 60 is formed from a rigid, resinous material, for example. The fin 60 is pivotably fixed to the extended part 512 of the first support part 51A via the fixing plate 53. The fin 60 is a plate-like part that extends in one direction and that includes a pivot shaft 61 at the proximal end part 60b at one end in the longitudinal direction. The proximal end part 60b of the fin 60 has an insertion hole 60c (see FIGS. 3 and 4) through which the pivot shaft 61 can be inserted. The fin 60 is disposed with the insertion hole 60e aligned in axial direction X.

As shown in FIGS. 3 and 4, the pivot shaft 61 pivotably supports the fin 60 with respect to the first support part 51A. The pivot shaft 61 is a pin element such as a fixing bolt that detachably supports the fin 60. Male threads 61a are formed at the end of the pivot shaft 61 to be screwed into the female-threaded portion 53b of the fixing plate 53. The pivot shaft 61 is inserted through the insertion hole 60e and tightened into the female-threaded portion 53b of the fixing plate 53. The fin 60 thereby includes the fixing plate 53 so as to pivotably move about the pivot shaft 61.

As shown in FIG. 2, the line guide part 60a at the longitudinal end of the fin 60 forms one edge of a flat portion extending in axial direction X and faces the line guide groove 52a of the line roller 52 in holding position P1. In holding position P1, the line guide part 60a is in close proximity to the line roller 52 with a gap S therebetween. Even if, due to a knot or the like formed in fishing line L during winding, fishing line L is larger than the gap S, the fin 60 can be pushed by the knot or the like to pivotably move into the pivot position P2. The gap S between the line roller 52 and the line guide part 60a of fin 60 is approximately 1 mm, for example.

As shown in FIG. 4, the first support part 51A has a spring element 54 (holding part, biasing element) that holds the line guiding part 60a in holding position P1, in which the line guide part 60a faces the line roller 52. The spring element 54 is a coiled spring. One end 54a of the spring element 54 is fixed to the first support part 51A, and the other end 54b is fixed to the proximal end part 60b of the fin 60 with the pivot shaft 61 inserted through coiled portion 54c. The spring element 54 biases the fin 60 in the return direction E2 (second direction) opposite the guide direction E1 (first direction) that guides the fishing line L onto the spool 4 around the pivot shaft 61.

The operation of the line guide mechanism 5 for a spinning reel with the above-described configuration will now be described in detail based on the drawings.

As shown in FIGS. 1 to 4, the spinning reel according to the present embodiment is equipped with a spool 4, rotor arms 32A, 32B for winding fishing line L around spool 4, first support part 51A supported by the first rotor arm 32A, and line guide mechanism 5 comprising a line roller 52 that is provided on the first support part 51A and that guides fishing line L onto the spool 4, and a fin 60 with a proximal end part 60b provided on the first support part 51A and a pivotable line guide part 60a that faces the line roller 52.

In the line guide mechanism 5 of the present embodiment, the line guide part 60a of the fin 60 facing the line roller 52 can pivot, so that when a knot or the like in the fishing line L passes through the line guide part 60a of the fin 60, the fin 60 pivots together with the line guide direction E1. Therefore, damage to the fin 60 due to the intense contact of the knot with the line guide part 60a can be prevented.

Further, in the present embodiment, as the knot passes through the line guide part 60a of the fin 60, the pivoting of the fin 60 reduces the impact of the knot in the fishing line L against the fin 60. Therefore, the discomfort that is transmitted to the hand of the user via the first rotor arm 32A including the fin 60 can be minimized.

In addition, in the present embodiment, the proximal end part 60b has a pivot shaft 61 that pivotably supports the fin 60 with respect to the first support part 51A. Therefore, when the knot passes through the line guide part 60a of the fin 60, the fin 60 pivots about the pivot shaft 61 disposed at the proximal end part 60b. Here, since the pivot shaft 61 is disposed at the proximal end part 60b, which is farthest from the line guide part 60a of the fin 60, a large pivot radius can be obtained, so that even the small contact force of a knot passing through the line guide section 60a can easily cause pivoting, thereby minimizing the discomfort felt in the hand of the user during contact.

Further, in the present embodiment, the pivot shaft 61 is a detachable pin element that supports the fin 60. Therefore, a pin element such as a fixing bolt is the pivot shaft 61, and the fin 60 can be smoothly rotated and pivoted about the pin element, so that the impact during passage of the knot can be reduced.

In the present embodiment, the first support part 51A holds the line guide part 60a in holding position P1 to face the line roller 52, and the fin 60 includes a spring element 54 that biases the fin in the return direction E2, opposite the guide direction E1 in which the fishing line L is guided onto the spool 4 around the pivot shaft 61.

As a result, when a knot passes through the line guide part 60a of the fin 60, the line guide part 60a, from holding position P1, pivots about the pivot shaft 61 in guide the direction E1, and, due to the biasing force of the spring element 54, the fin 60, by moving in return direction E2, can return to original holding position P1. In other words, in the present embodiment, when a knot does not pass through line guide part 60a of the fin 60, the line guide part 60a of the fin 60 can always be positioned opposite the line roller 52 due to the biasing force of the spring element 54, and fishing line L can be held between the line roller 52 and the line guide part.

The line guide mechanism 5 for a spinning reel according to the present embodiment with the configuration described above can prevent damage to the fin 60 and minimize the discomfort felt in the hand of the user when a knot passes through the fin 60.

Other embodiments of the line guide mechanism for a spinning reel according to the present disclosure will be described. It should be noted that constituent elements having the same functions as those of the first embodiment described above are denoted by the same reference numerals, and detailed descriptions thereof will be omitted to avoid duplication.

### Second Embodiment

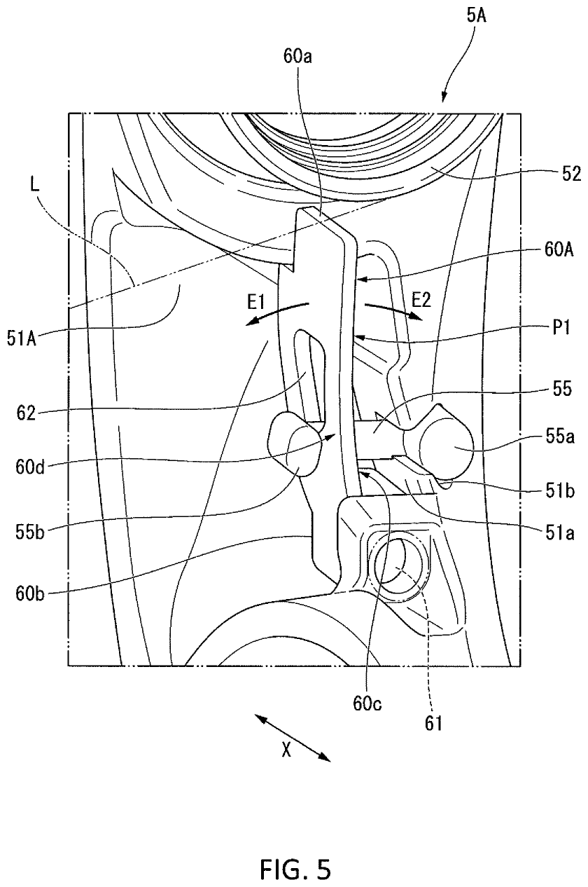

As shown in FIG. 5, a line guide mechanism 5A for a spinning reel according to a second embodiment is configured with a first elastic element 55 (biasing element) in the middle of a fin 60A in the longitudinal direction as a holding part for holding the line guide part 60a in holding position P1 facing the line roller 52. In other words, the second embodiment has a configuration in which the first elastic element 55 replaces the spring element 54 (see FIG. 4) of the first embodiment.

The fin 60A has an elongated hole 62 extending in the longitudinal direction and penetrating in the thickness direction at a position between the line guide part 60a and the proximal end part 60b in the longitudinal direction. A first support part 51A has a first wall surface 51a facing the outer peripheral surface 60c of the fin 60A. The first wall surface 51a has an engagement recess 51b that faces the elongated hole 62 of the fin 60A and accommodates a first engagement portion 55a at one end of the first elastic element 55.

The first elastic element 55 is, for example, an elongated rubber element that can extend in the longitudinal direction. Both ends of the first elastic element 55 have engagement portions 55a, 55b that bulge in a direction that intersects the longitudinal direction. The first elastic element 55 is oriented with its longitudinal direction orthogonal to axial direction X and is disposed to connect the first wall surface 51a of the first support part 51A and the fin 60A. The first elastic element 55 has a first engagement portion 55a engaged with the engagement recess 51b of the first support part 51A, and a second engaging portion 55b engaged with an inner surface 60d of the fin 60A when inserted into the elongated hole 62 of the fin 60A. The first elastic element 55 supported by the fin 60A is located closer to the line guide part 60a side than the pivot shaft 61 side.

The first elastic element 55 stretches and deforms when the fin 60A pivots in the guide direction E1. The first elastic element 55 causes the fin 60A pivoting in guide the direction E1 for guiding fishing line L to the spool to return in the return direction E2 opposite the guide direction E1 by an elastic force, thereby holding the line guide part 60a of the fin 60A in a position facing the line roller 52.

In the second embodiment, when a knot passes through the line guide part 60a of the fin 60A, the line guide part 60a of the fin 60A pivots about the pivot shaft 61 from holding position P1 in the guide direction E1. At this time, the fin 60A pivots to the pivot position with the first elastic element 55 stretched and deformed. Thereafter, the fin 60A, which has pivoted to the pivot position, moves in the return direction E2 due to the biasing force of the first elastic element 55 and returns to the original holding position P1. In other words, in the second embodiment, when a knot does not pass through the line guide part 60a of the fin 60A, the line guide part 60a of the fin 60A, by the biasing force of the first elastic element 55, can always be positioned in the holding position P1 facing the line roller 52, and fishing line L can be held between the line roller 52 and the line guide part 60a.

### Third Embodiment

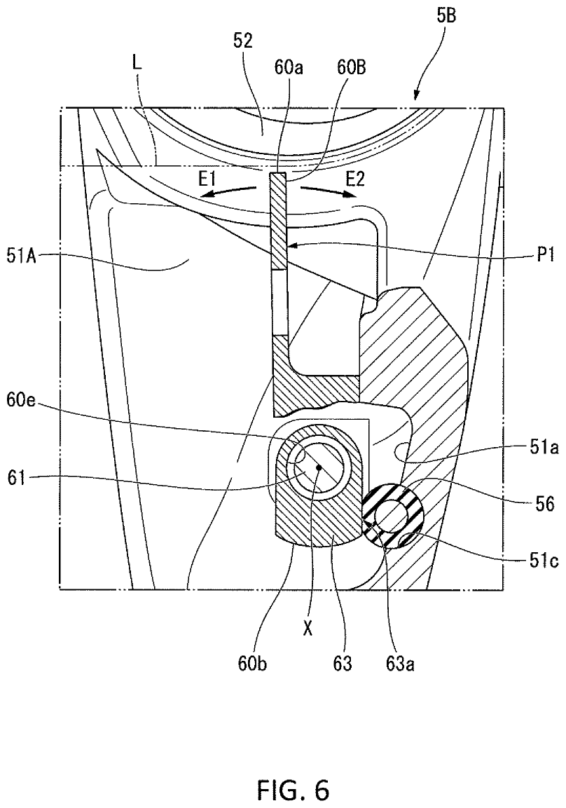

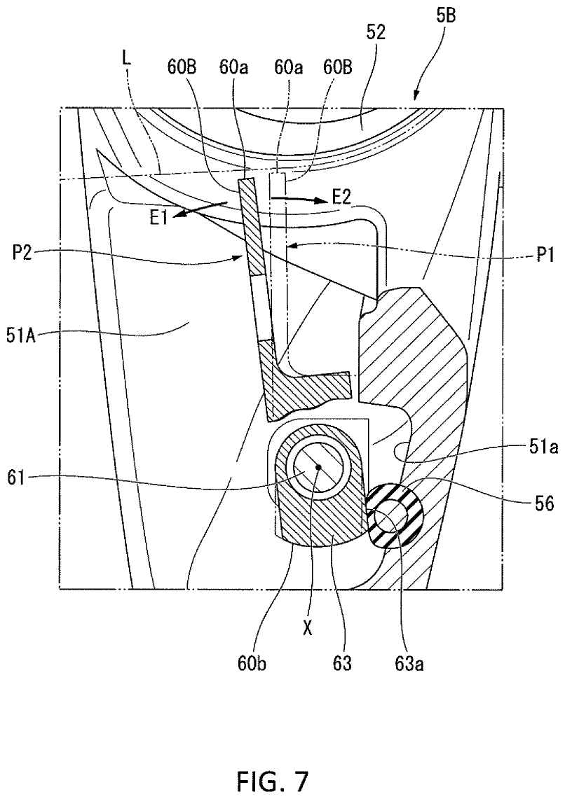

As shown in FIGS. 6 and 7, the line guide mechanism 5B for a spinning reel according to a third embodiment includes a second elastic element 56 (biasing element) at the proximal end part 60b of the fin 60B as a holding part for holding the line guide part 60a in holding position P1 facing the line roller 52. In other words, the third embodiment has a configuration in which the second elastic element 56 replaces the first elastic element 55 (see FIG. 5) of the second embodiment.

The proximal end part 60b of the fin 60B has an abutment portion 63 that projects farther down from the insertion hole 60e through which the pivot shaft 61 is inserted. The second elastic element 56 is disposed on the first wall surface 51a of the first support part 51A in a position opposite the abutment portion 63 of the fin 60B. In other words, the surface of the abutment portion 63 facing the second elastic element 56 is abutting surface 63a that abuts the second elastic element 56.

The second elastic element 56 is, for example, a hollow cylindrical element made of rubber and is disposed with the cylinder axis direction facing in axial direction X. The second elastic element 56 is fixed by partially engaging a recess 51c formed in the first wall surface 51a of the first support part 51A.

The second elastic element 56 need not be a hollow cylindrical rubber element, but can be a solid and generally soft rubber element or the like. Further, the cross-sectional shape of the second elastic element 56 is also not limited to a circular shape, but can be rectangular, for example.

When the fin 60B pivots in guide direction E1, the abutment portion 63 moves towards the first wall surface 51a of the first support part 51A, causing the second elastic element 56, which is fixed to the first wall surface 51a by the abutment portion 63, to undergo compressive deformation and become flattened. The second elastic element 56 causes the fin 60B pivoting in the guide direction E1 for guiding fishing line L to the spool to return in return direction E2 opposite guide direction E1 by an elastic force, thereby holding the line guide part 60a of the fin 60B in the position facing the line roller 52.

In the third embodiment, when a knot passes through the line guide part 60a of the fin 60B, the line guide part 60a of the fin 60B pivots about the pivot shaft 61 from holding position P1 in the guide direction E1. At this time, the fin 60B pivots to the pivot position P2 while causing the second elastic element 56 to undergo compressive deformation. Thereafter, the fin 60B, which has pivoted to the pivot position P2, moves in the return direction E2 due to the biasing force of the second elastic element 56 and returns to the original holding position P1. In other words, in the third embodiment, when a knot does not pass through the line guide part 60a of the fin 60B, the line guide part 60a of the fin 60B, by the biasing force of the second elastic element 56, can always be positioned in the holding position P1 facing the line roller 52 and the fishing line L can be held between the line roller 52 and the line guide part 60a.

### Fourth Embodiment

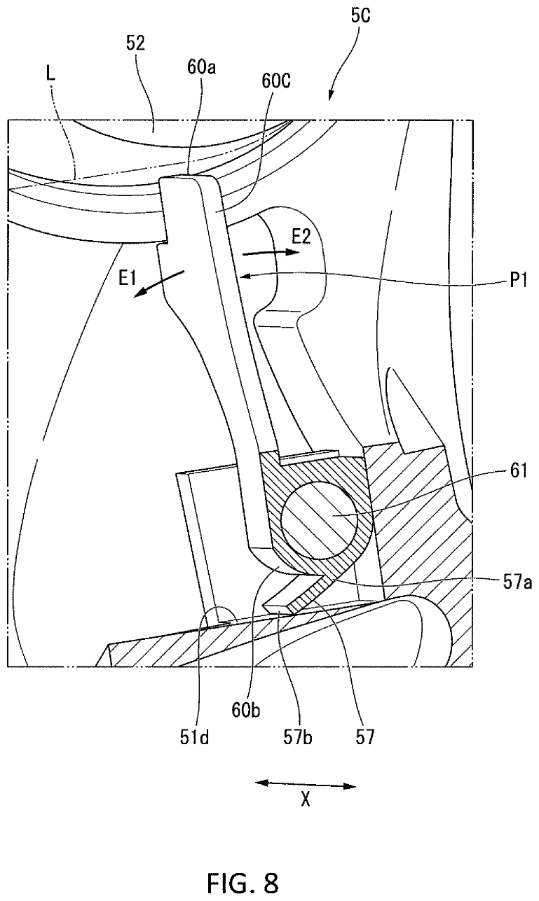

As shown in FIG. 8, a line guide mechanism 5C for a spinning reel according to a fourth embodiment is configured with a flexible projection 57 (biasing element) at the proximal end part 60b of a fin 60C as a holding part for holding the line guide part 60a in holding position P1 facing the line roller 52. In other words, the fourth embodiment has a configuration in which the flexible projection 57 replaces the first elastic element 55 (see FIG. 5) of the second embodiment and the second elastic element 56 (see FIGS. 6 and 7) of the third embodiment.

The proximal end part 60b of the fin 60C has a flexible projection 57 that is located opposite the line guide part 60a with the pivot shaft 61 therebetween. The flexible projection 57 has a fixed portion 57a at one end fixed to the proximal end part 60b and a projecting end 57b at the other end projecting obliquely inwardly from the fixed portion 57a. The flexible projection 57 is flexibly deformable at the connecting portion (fixed portion 57a) with the proximal end part 60b of the fin 60C. In other words, when the fin 60C pivots in the guide direction E1, the flexible projection 57 bends in the direction in which the distance between the projecting end 57b and the proximal end part 60b decreases, and a reaction force is generated on the side opposite to the bending direction.

The first support part 51A has a second wall surface 51d that is essentially orthogonal to the longitudinal direction of the fin 60C in the holding position P1 and faces the flexible projection 57. The projecting end 57b of the flexible projection 57 of the fin 60C abuts the second wall surface 51d in the holding position P1.

When the fin 60C pivots in the guide direction E1, the flexible projection 57 bends and deforms between the proximal end part 60b of the fin 60C and the second wall surface 51d of the first support part 51A. The flexible projection 57 returns the fin 60C pivoting in guide direction E1 for guiding fishing line L onto the spool 4 to return in the return direction E2 opposite the guide direction E1 by an elastic force, and holds the line guide part 60a of the fin 60C in a position opposite the line roller 52.

In the fourth embodiment, when a knot passes through the line guide part 60a of the fin 60C, the line guide part 60a of the fin 60C pivots about the pivot shaft 61 from the holding position P1 in the guide direction E1. At this time, the fin 60C pivots to the pivot position while bending and deforming the flexible projection 57. Thereafter, the fin 60C, which has pivoted to the pivot position, moves in the return direction E2 due to the reaction force of the flexible projection 57 and returns to original holding position P1. In other words, in the fourth embodiment, when a knot does not pass through the line guide part 60a of the fin 60C, the line guide part 60a of the fin 60C, by the biasing force of the flexible projection 57, can always be positioned in the holding position P1 facing the line roller 52, and the fishing line L can be held between the line roller 52 and the line guide part 60a.

### Fifth Embodiment

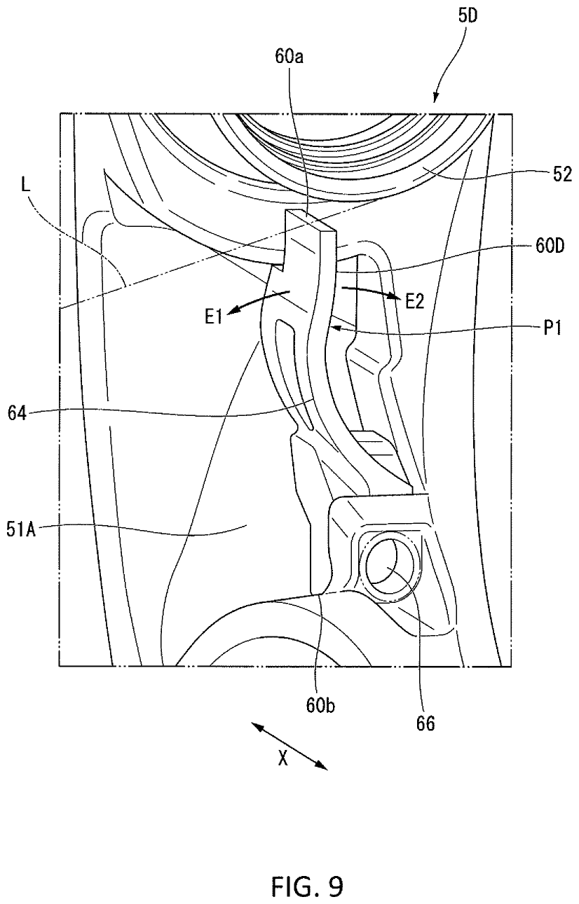

As shown in FIG. 9, a line guide mechanism 5D for a spinning reel according to a fifth embodiment includes the pivotable portion in a fin 60D itself. In other words, the fifth embodiment has a configuration in which the holding parts (spring element 54, first clastic element 55, second elastic element 56, and flexible projection 57) and the pivot shaft 61 for pivoting the fin 60D of the first to fourth embodiments are not provided.

The proximal end part 60b of the fin 60D is fixed to the first support part 51A by a fixing bolt 66. In other words, the fin 60D is configured not to rotate (pivot) about the fixing bolt 66. The fin 60D has a curved section 64 (connecting portion, elastically deformable portion) that connects the line guide part 60a to the proximal end part 60b so as to pivotably move at a position between the proximal end part 60b and the line guide part 60a. The curved section 64 has a bowed shape having a convex surface that is convex in guide direction E1 as seen from axial direction X and is elastically deformable. When the fin 60D pivots in guide direction E1, the curved section 64 deforms in the direction opposite the direction of curve, generating a reaction force. The curved section 64 then causes the fin 60D pivoting in guide direction E1 for guiding fishing line L onto the spool to return in return direction E2 opposite guide direction E1 by an elastic force, thereby holding the line guide part 60a of the fin 60D in a position facing the line roller 52.

In the fifth embodiment, when a knot passes through the line guide part 60a of the fin 60D, the line guide part 60a of the fin 60D pivots about the pivot shaft 61 from holding position P1 in guide direction E1. At this time, the fin 60D pivots to the pivot position P2 due to the deformation of the curved section 64. Thereafter, the fin 60D, which has pivoted to the pivot position P2, moves in the return direction E2 due to the reaction force of the curved section 64 and returns to original holding position P1. In other words, in the fifth embodiment, when a knot does not pass through the line guide part 60a of the fin 60D, the line guide part 60a of the fin 60D, by the basing force of the curved section 64, can always be positioned in the holding position P1 facing the line roller 52, and the fishing line L can be held between the line roller 52 and the line guide part 60a.

Further, in the fifth embodiment, when a knot in fishing line L passes through the line guide part 60a of the fin 60D, a separate element to return the fin 60D to its original position is not needed since the fin itself bends at the curved section 64 and pivots, which improves the case of assembly during manufacture and provides an excellent structure in which no damage or the like can occur to any biasing element that might be provided separately.

### Sixth Embodiment

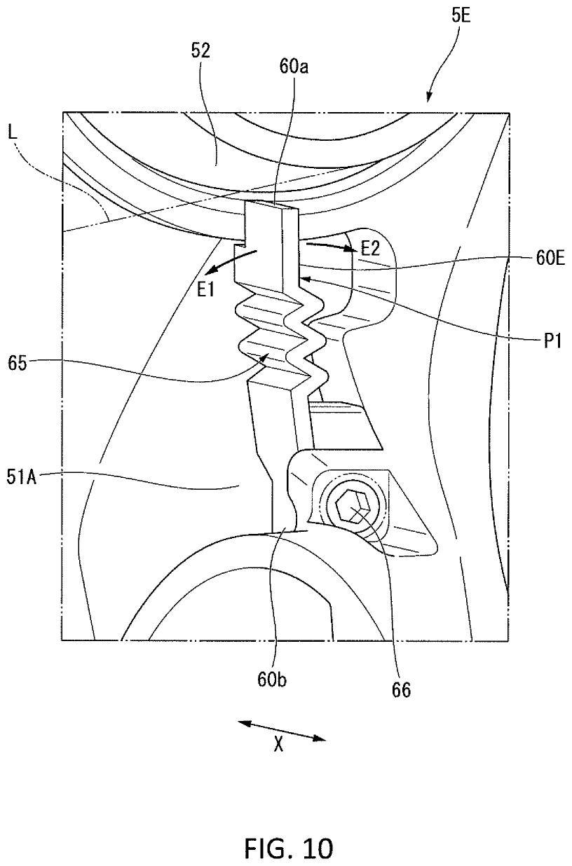

As shown in FIG. 10, a line guide mechanism 5E for a spinning reel according to a sixth embodiment is configured with a pivotable portion in a fin 60E itself, similarly to the fifth embodiment. In other words, the sixth embodiment has a configuration in which an accordion-like section 65 replaces the curved section 64 (see FIG. 9) of the fifth embodiment.

The proximal end part 60b of the fin 60E is fixed to the first support part 51A by a fixing bolt 66. In other words, the fin 60E is configured not to rotate (pivot) about the fixing bolt 66. The fin 60E has an accordion-like section 65 (connecting portion, elastically deformable portion) that connects the line guide part 60a to the proximal end part 60b so as to pivotably move at a position between the proximal end part 60b and the line guide part 60a. The accordion-like section 65 is formed by alternately bending in the guide direction E1 and return direction E2 as seen from axial direction X, and overall is elastically deformable. When the fin 60E pivots in the guide direction E1, the accordion-like section 65 deforms, generating a reaction force. The accordion-like section 65 then causes the fin 60E pivoting in the guide direction E1 for guiding fishing line L onto the spool to return in return direction E2 opposite the guide direction E1 by an elastic force, thereby holding the line guide part 60a of the fin 60E in a position facing line roller 52.

In the sixth embodiment, when a knot passes through the line guide part 60a of the fin 60E, the line guide part 60a of the fin 60E pivots about the pivot shaft 61 from the holding position P1 in the guide direction E1. At this time, the fin 60E pivots to the pivot position P2 due to the deformation of the accordion-like section 65. Thereafter, the fin 60E, which has pivoted to the pivot position P2, moves in the return direction E2 and returns to the original holding position P1 by the reaction force of the accordion-like section 65. In other words, in the sixth embodiment, when a knot does not pass through the line guide part 60a of the fin 60E, the line guide part 60a of fin 60E, by the biasing force of the accordion-like section 65, can always be positioned in the holding position P1 facing the line roller 52, and the fishing line L can be held between the line roller 52 and the line guide part 60a.

Further, in the sixth embodiment, when a knot in the fishing line L passes through the line guide part 60a of the fin 60E, a separate element to return the fin 60E to its original position is not needed since the fin itself pivots by deforming at the accordion-like portion 65, which improves the case of assembly during manufacture and provides an excellent structure in which no damage or the like can occur to a separate biasing element.

### Seventh Embodiment

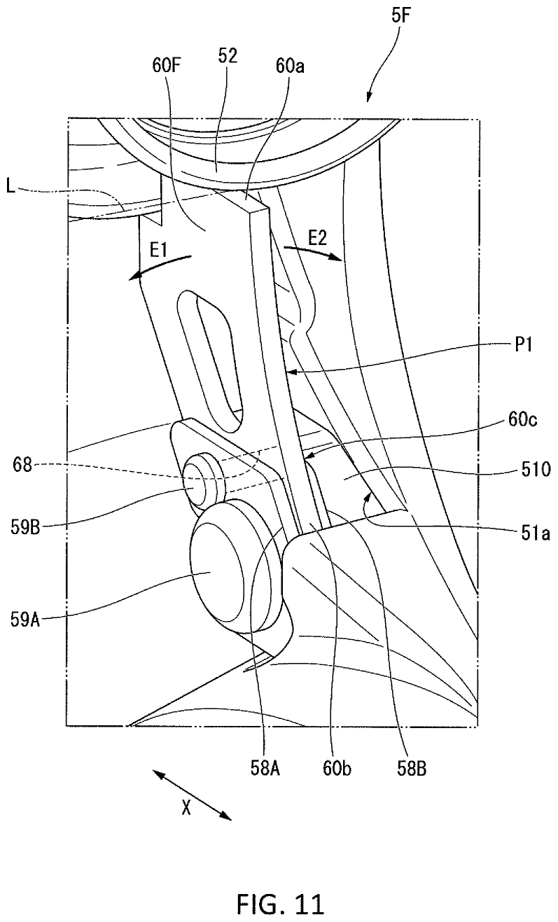

As shown in FIG. 11, a line guide mechanism 5F for a spinning reel according to a seventh embodiment has a configuration in which a pair of elastic holding bodies 58A, 58B (biasing elements) grip the proximal end part 60b of a fin 60F, acting as the holding part to hold the line guide part 60a in the holding position P1 facing the line roller 52. In other words, the seventh embodiment has a configuration in which elastic holding bodies 58A, 58B replace the first elastic element 55 of the second embodiment and the second elastic element 56 of the third embodiment.

A fixing hole 68 formed in the thickness direction of the fin 60F at the proximal end part 60b. A spacer 510 is fixed to the first wall surface 51a of the first support part 51A opposite the outer peripheral surface 60c of the fin 60F. The inner surface 511a of the spacer 510 has a female-threaded portion (not shown) into which the first fixing bolt 59A and the second fixing bolt 59B are screwed.

The elastic holding bodies 58A, 58B are flat elements respectively made of rubber, for example, and include the proximal end part 60b of the fin 60F interposed therebetween. The clastic holding bodies 58A, 58B have bolt holes (not shown) in one side through which the first fixing bolt 59A can be inserted and bolt holes (not shown) at the other end through which the second fixing bolt 59B can be inserted. The first fixing bolt 59A only passes through the pair of elastic holding bodies 58A, 58B and screws into the spacer 510 the pair of elastic holding bodies 58A, 58B and screwed into the spacer 510. The first fixing bolt 59A is located outside of the proximal end part 60b of the fin 60F. The second fixing bolt 59B passes through the elastic holding bodies 58A, 58B, between which the fin 60F together with the fixing holes 68 of the fin 60F is interposed, and screwed into the spacer 510.

The elastic holding bodies 58A, 58B elastically deform as the fin 60F pivots in the guide direction E1. The clastic holding bodies 58A, 58B cause the fin 60F pivoting in the guide direction E1 for guiding fishing line L onto the spool 4 to return in return direction E2 opposite guide direction E1 by an elastic force, thereby holding the line guide part 60a of the fin 60F in a position facing the line roller 52.

In the seventh embodiment, when a knot passes through the line guide part 60a of the fin 60F, the line guide part 60a of the fin 60F pivots about the pivot shaft 61 from the holding position P1 in the guide direction E1. At this time, the fin 60F pivots to the pivot position P2 with the elastic holding bodies 58 58B elastically deformed. Thereafter, the fin 60F, which has pivoted to the pivot position P2, moves in the return direction E2 due to the biasing force of the elastic holding bodies 58A, 58B and returns to the original holding position P1. In other words, in the seventh embodiment, when a knot does not pass through the line guide part 60a of the fin 60F, the line guide part 60a of fin 60F, by the biasing force of the elastic holding bodies 58A, 58B, can always be positioned in holding position P1 facing the line roller 52, and fishing line L can be held between the line roller 52 and the line guide part 60a.

Embodiments of a line guide mechanism for a spinning reel according to the present disclosure were described above; however, these embodiments were presented as examples and are not intended to limit the scope of the disclosure. The embodiments can be implemented in various other forms, and various omissions, substitutions, and modifications can be made insofar as they do not depart from the essence of the disclosure. Embodiments and variants thereof include, for example, those that can be readily envisaged by a person skilled in the art, those that are substantially identical, and those that are of equal scope.

For example, the shape of the first support part 51A is not limited to the above-described embodiment, but can be changed as deemed suitable for the structure of the line guiding mechanism, such as the type of pivoting employed and fin shape.

Further, other configurations such as those pertaining to the shape and size of the reel body 10, handle 2, rotor 3, spool 4, etc., can be changed as deemed appropriate.

What is claimed is:

1. A line guide mechanism for a spinning reel comprising:
a spool;
rotor arms configured to wind fishing line around the spool;
a support part supported by the rotor arms;
a line roller disposed on the support part and configured to guide the fishing line onto the spool; and
a fin having a proximal end part disposed on the support part and a distal end part facing the line roller and being configured to pivotably move.

2. The line guide mechanism for a spinning reel according to claim 1, wherein
the proximal end part of the fin has a pivot shaft supporting the fin so as to pivotably move with respect to the support part.

3. The line guide mechanism for a spinning reel according to claim 2, wherein
the pivot shaft is a detachable pin element and supports the fin.

4. The line guide mechanism for a spinning reel according to claim 2, wherein
the support part has a holding part holding the fin in a holding position in which the distal end part of the fin faces the line roller, and
the holding part has a biasing element configured to bias the fin in a second direction opposite a first direction to guide the fishing line onto the spool around the pivot shaft.

5. The line guide mechanism for a spinning reel according to claim 1, wherein
the fin has a connecting portion disposed between the proximal end part and the distal end part and pivotably connecting the distal end part to the proximal end part.

6. The line guide mechanism for a spinning reel according to claim 5, wherein
the connecting portion has an elastically deformable portion.
